(19) United States
(12) Patent Application Publication
(10) Pub. No.: US 2011/0193874 A1
(43) Pub. Date: Aug. 11, 2011

(54) COLOR ELECTRONIC PAPER KEYPAD DEVICE

(75) Inventors: Sun-Tae JUNG, Yongin-si (KR); Sung-Soo Park, Suwon-si (KR); Yu-Sheop Lee, Suwon-si (KR); Joo-Hoon Lee, Yongin-si (KR)

(73) Assignee: Samsung Electronics Co., Ltd., Suwon-si (KR)

(21) Appl. No.: 13/022,127

(22) Filed: Feb. 7, 2011

(30) Foreign Application Priority Data
Feb. 5, 2010 (KR) 10-2010-0010751

(51) Int. Cl. G09G 5/02

(52) U.S. Cl. 345/589

(57) ABSTRACT

A color electronic paper keypad device is provided that includes an electronic paper sheet having a plurality of electrode patterns. One or more of the plurality of electrode patterns displays a color depending on whether an electric field is applied. The device also includes a color display disposed over the electronic paper sheet. The color display changes the displayed color depending on whether a second electric field is applied. An illumination light reflects from or transmits through the color display to change the displayed color of the one or more electrode patterns. The device further includes a front light unit for illuminating said color display.

### PRIORITY

This application claims the priority under 35 U.S.C. §119(a) to an application entitled “Color Electronic Paper Keypad Device” filed in the Korean Intellectual Property Office on Feb. 5, 2010 and assigned Serial No. 10-2010-0010751, the contents of which are incorporated herein by reference.

### BACKGROUND OF THE INVENTION

1. Field of the Invention

The present invention relates generally to a color electronic paper keypad device, and more particularly, to a color electronic paper keypad device that is able to change the colors of a plurality of the electrode patterns on the electronic paper sheet.

2. Description of the Related Art

In general, a portable communication units are carried by users, making it possible for the users to perform wireless communication with other users. Examples of such a portable communication units include Hand Held Products (HHP), CT-2 cellular phones, digital phones, Personal Communication Service (PCS) phones and Personal Digital Assistants (PDA). Communication units may be classified into many types depending on their exterior configuration. For example, wireless communication terminals may be classified into bar-type, flip-type, folder-type and slide-type terminals depending on their exterior configuration. The conventional portable terminal, as described above, includes an antenna device, a data input/output device and a data transmitting-receiving unit. A data input device, or a keypad device, is universally used, which allows the user to input data using his/her finger.

For proper functioning of the portable communication unit, the complexity of the user interface is increased in proportion to convenience. More recently, the use of Short Message Service (SMS) and mobile internet has increased. Furthermore, the performance of a smart phone has been approaching that of a personal computer, and the market-share of the smart phone has increased in the portable communication unit market.

Accordingly, various kinds of input modes are needed depending on the user's environment. Alphanumeric letters, figures and characters are printed on a restricted area of the keypad device. However, the keypad device may have a complicated configuration, making it difficult for the user to input the data.

A touch screen installed over a display has been widely used recently. When using the touch screen, the User Interface (UI) may be changed to meet the user's environment using the Liquid Crystal Display (LCD).

However, when pushing the keypad, the user cannot sense the switch-clicking Also, when inputting the data using qwerty keys, the frequency of input errors increases. Further, the power consumption increases because the touch screen remains in an ON-state. Additionally, the visibility may be good in a dark room, but it is not good when it is bright outside.

A keypad device employing electronic paper (E-paper), which includes dome type switches located below the electronic paper, has been developed. This keypad device enables a key map of the keypad to be changed, while maintaining the sense of the switch-clicking.

However, the conventional keypad device employing the electronic paper only displays black color or white color. In other words, the colors available in this keypad device are restricted, and thus the design of the keypad is degraded.

### SUMMARY OF THE INVENTION

The present invention has been made to address at least the above-mentioned problems and/or disadvantages and to provide at least the advantages described below. Accordingly, an aspect of the present invention provides a color electronic paper keypad device which enables colors of the alphanumeric letters, the figures and the characters provided on the keypad to be changed into other colors according to a change in the user's mode.

According to another aspect of the present invention, the color electronic paper keypad device can reduce power consumption by employing an electronic paper sheet with lower power consumption, which can improve the visibility of the product indoors and outdoors.

According to an aspect of the present invention, a color electronic paper keypad device is provided. The device includes an electronic paper sheet having a plurality of electrode patterns. One or more of the plurality of electrode patterns displays a color depending on whether an electric field is applied. The device also includes a color display disposed over the electronic paper sheet, changing the displayed color depending on whether a second electric field is applied. An illumination light is reflected from or transmitted through the color display to change the displayed color of one or more the electrode patterns. The device further includes a front light unit for illuminating the color display.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a side-sectional view of the color electronic paper keypad device, according to an embodiment of the present invention;

FIG. 2 is a top-plan view of the electronic paper sheet included in the color electronic paper keypad device, according to an embodiment of the present invention;

FIG. 3 is a side-sectional view illustrating a state, in which the color electronic paper keypad device is being used, according to an embodiment of the present invention;

FIG. 4 is a side-sectional view illustrating another state, in which the color electronic paper keypad device is being used, according to an embodiment of the present invention;

FIG. 5 is a side-sectional view illustrating an operating state of the color electronic paper keypad device, according to an embodiment of the present invention; and

FIG. 6 is a top-plan view illustrating another operating state of the color electronic paper keypad device, according to an embodiment of the present invention.

### DETAILED DESCRIPTION OF EMBODIMENTS OF THE PRESENT INVENTION

Embodiments of the present invention are described in detail with reference to the accompanying drawings. The same or similar components are designated by the same or similar reference numerals although they are illustrated in different drawings. Detailed descriptions of constructions or processes known in the art may be omitted to avoid obscuring the present invention.

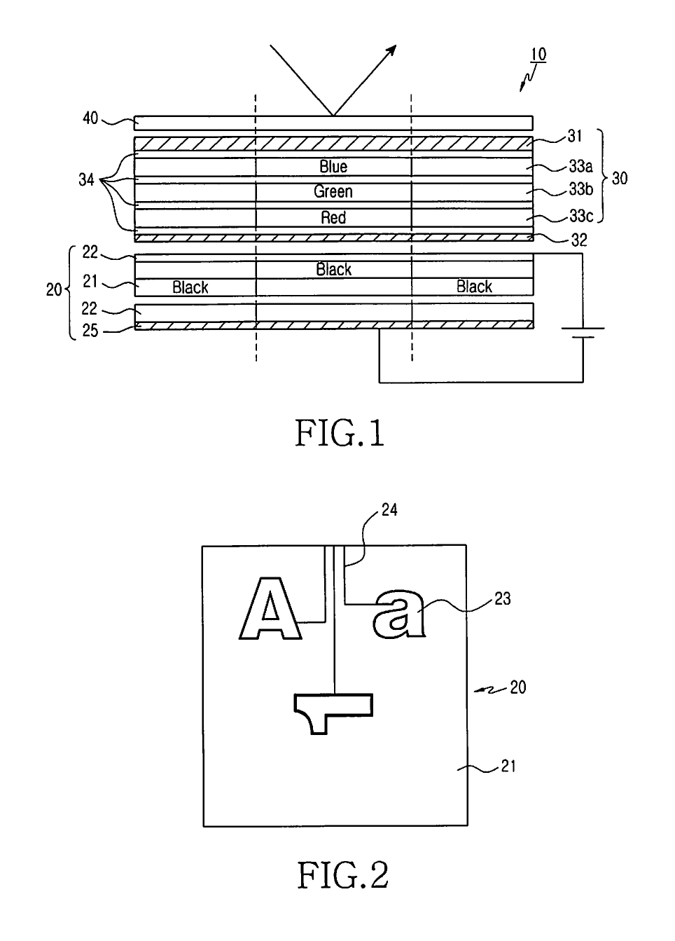

As illustrated in FIGS. 1 and 6, a color electronic paper keypad device 10 includes an electronic paper sheet 20 including a plurality of electrode patterns 23, a color display 30, and a front light unit 40. The electronic paper sheet 20 is disposed below the color display 30. The electronic paper sheet displays the black color or the white color depending on whether the electric field is applied. The color display 30 changes the colors thereof into red, green or blue depending on whether the electric field is applied, so that it reflects or transmits the light from the front light unit as described below. Also, the color display 30 is disposed above the electronic paper sheet 20 in order to change the colors of the plurality of the electrode patterns 23. The front light unit 40 is disposed over the color display for illuminating the color display.

The electronic paper sheet 20 may include an ElectroPhoretic-Display (EPD).

As illustrated in FIGS. 1 and 2, the electronic paper sheet 20 includes an electronic ink layer 21, electrode layers 22, a plurality of electrode patterns 23, a plurality of wirings 24 and a protective layer 25. The electronic ink layer 21 displays the white or the black color by moving dye, which is contained within a capsule, in an upward or a downward direction depending on whether the electric field is applied. The electrode layers 22 are disposed over and under the electronic ink layer 21, respectively, in order to apply the electric field to the electronic ink layer 21. The electrode patterns 23 are disposed under the electronic ink layer 21 in order to apply the electric field. The wirings 24 are electrically connected to the electrode patterns 23. The electronic ink layer 21 is provided with the protective layer 25 in order to prevent moisture from penetrating into the electronic paper sheet 20.

As illustrated in FIGS. 2 and 6, the electrode patterns 23 include one of alphanumeric letters, figures and characters.

As illustrated in FIGS. 1 to 6, the color display 30 includes upper and lower substrates 31 and 32, and a liquid crystal layer 33. The upper and lower substrates 31 and 32 are disposed over and under the liquid crystal layer 33, respectively, in order to prevent the moisture from penetrating into the color display 30. The liquid crystal layer 33 includes three-color layers 33a, 33b, and 33c, which respectively correspond to a red color layer, a green color layer and a blue color layer, in order to reflect or transmit the light. Each of the three-color layers 33a, 33b, and 33c, is provided with an electrode layer 34. The liquid crystal layer 33 is provided between the upper and lower substrates 31 and 32 in order to change the colors of the three color layers 33a, 33b, and 33c and the colors of the electrode patterns 23 depending on whether or not the electric filed is applied through the electrode layers 34.

The Front Light Unit (FLU) 40 may include, for example, a light emitting device and a light guide plate.

The light emitting device includes a Light Emitting Diode (LED), but other types of light emitting devices are also available.

The color display 30 includes a cholesteric liquid crystal display, but other types of color displays are also available.

As described above, a portable communication unit has been exemplified as the color electronic paper keypad device, according to an embodiment of the present invention. However, the portable communication unit is not necessarily limited to a mobile communication terminal. The present invention may be applied to various kinds of terminals employing the keypad device, such as, for example, the bar-type terminal and the sliding-type terminal.

The portable communication device according to the present invention includes all kinds of information communication units, multimedia units and application units thereof, such as, a Portable Multimedia Player (PMP), an MP3 player, a navigation, a game console, a notebook computer, an advertisement plate, a TV set, a digital broadcasting player, a PDA and a smart phone, in addition to all kinds of mobile communication terminals operating on the basis of a communication protocol adapted to various communication systems.

The operation of the color electronic paper keypad device, according to an embodiment of the present invention, is described with reference to FIGS. 1 to 6.

As illustrated in FIGS. 1 to 6, the color electronic paper keypad device 10 includes the electronic paper sheet 20 having the electrode patterns 23, the color display 30 and the front light unit 40.

The electronic paper sheet 20 includes the electronic ink layer 21, the electrode layer 22, the plurality of the electrode patterns 23, the plurality of the wirings 24 and the protective layer 25.

The color display 30 includes the upper and lower substrates 31 and 32, the electrode layers 34, and the liquid crystal layer 33 having three color layers 33a, 33b, 33c, which correspond to red, green and blue, respectively.

The front light unit 40 includes the light emitting device and the light guide plate.

The color display 30 is disposed over the electronic paper sheet 20, and the front light unit 40 is disposed over the color display 30.

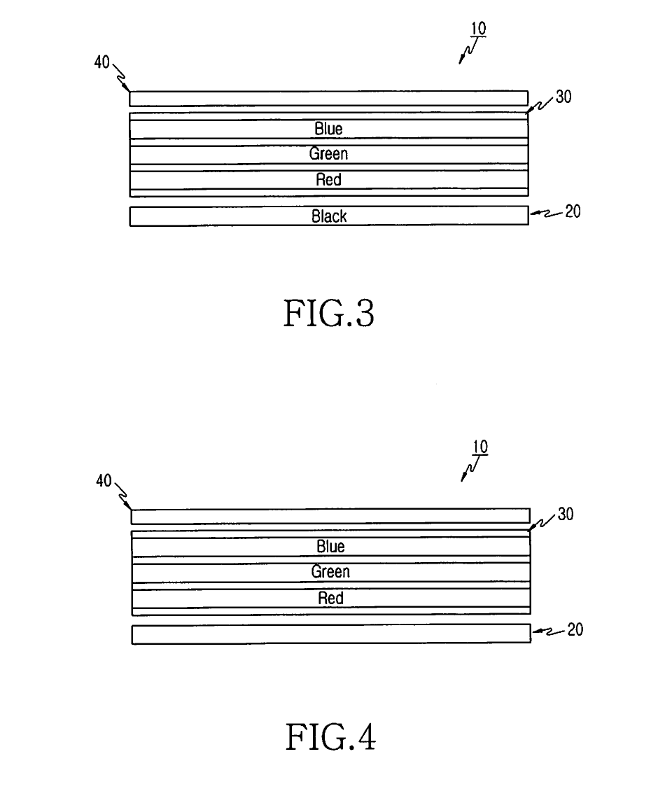

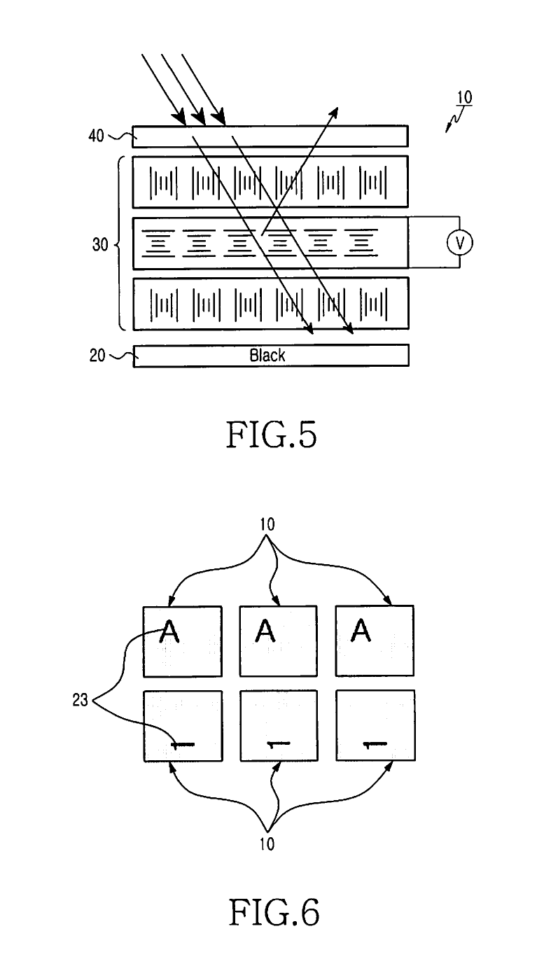

As illustrated in FIGS. 3 and 5, the electronic paper sheet 20 displays the black color when a positive (+) voltage is applied. The electrode patterns 23 (such as, the alphanumeric letters, the figures and the characters) display the black color.

As illustrated in FIG. 4, the electronic paper sheet 20 displays the white color when a negative (−) voltage is applied thereto. The electrode patterns 23 (such as, the alphanumeric letters, the figures and the characters) display the white color.

For the purpose of describing an embodiment of the present invention, it is assumed that the electrode patterns 23 display the black color. The black color may make the other colors visible more clearly.

As illustrated in FIGS. 1 to 6, the electric field is applied to the color display 30, so that the color display 30 is changed to display the color the user wants. The light from the front light unit 40 does not only illuminate the color display 30, but also reflects from or transmits through the color display 30. The color of the electrode patterns 23, which display the black color, are changed to another color, through the color display 30.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A color electronic paper keypad device comprising:
an electronic paper sheet including a plurality of electrode patterns, wherein one or more of the plurality of electrode patterns display a color depending on whether an electric field is applied;
a color display disposed over the electronic paper sheet that changes the displayed color depending on whether a second electric field is applied, wherein an illumination light reflects from or transmits through the color display to change the displayed color of the one or more electrode patterns; and
a front light unit for illuminating the color display.

2. The color electronic paper keypad device as claimed in claim 1, wherein said electronic paper sheet comprises:
an electronic ink layer displaying a black color or a white color by moving dye contained within a capsule in an upward or a downward direction depending on whether the electric field is applied;
the plurality of electrode patterns disposed under the electronic ink layer;
a plurality of wirings electrically connected to the plurality of the electrode patterns; and
a protective layer for prevention of moisture penetration.

3. The color electronic paper keypad device as claimed in claim 2, wherein the plurality of the electrode patterns comprise at least one of alphanumeric letters, figures and characters.

4. The color electronic paper keypad device as claimed in claim 1, wherein the color display comprises:
upper and lower substrates; and
a liquid crystal layer disposed between the upper and lower substrates and including three color layers, wherein the three color layers correspond to a red color layer, a green color layer and a blue color layer, each of the three color layers is provided with a respective electrode layer, the liquid crystal layer changes colors of the three color layers to thereby change the displayed color of the one or more electrode patterns, depending on whether the second electric field is applied.

5. The color electronic paper keypad device as claimed in claim 1, wherein the front light unit comprises a light emitting device and a light guide plate.

6. The color electronic paper keypad device as claimed in claim 1, wherein the color display comprises a cholesteric liquid crystal display.
